(19) United States
(12) Patent Application Publication
(10) Pub. No.: US 2020/0184216 A1
(43) Pub. Date: Jun. 11, 2020

(54) MACHINE CONTINUOUS LEARNING METHOD OF NEURAL NETWORK OBJECT CLASSIFIER AND RELATED MONITORING CAMERA APPARATUS

(71) Applicant: VIVOTEK INC., New Taipei City (TW)

(72) Inventor: Cheng-Chieh Liu, New Taipei City (TW)

(21) Appl. No.: 16/449,480

(22) Filed: Jun. 24, 2019

(30) Foreign Application Priority Data
Dec. 11, 2018 (TW) 107144593

(51) Int. Cl. G06K 9/00; G06K 9/62; G06N 3/04

(52) U.S. Cl. CPC G06K 9/00664; G06N 3/04; G06K 9/6263; G06K 9/6267

(57) ABSTRACT

A machine continuous learning method with a neural network object classifying function is applied to a monitoring camera apparatus having a processor with an object classifier. The machine continuous learning method includes utilizing the processor to receive an image, utilizing the object classifier to analyze the image for generating a first parameter and a second parameter, utilizing the processor to determine whether the first parameter belongs to at least one cluster established by human feedback, and utilizing the processor to output a label of the at least one cluster or the second parameter generated by the object classifier according to a determination result.

### BACKGROUND OF THE INVENTION

### 1. Field of the Invention

The present invention relates to an object classifying method and a related monitoring camera apparatus, and more particularly, to a machine continuous learning method with a neural network object classifying function and a related monitoring camera apparatus.

### 2. Description of the Prior Art

A monitoring image captured by a monitoring camera can include a plurality of objects, and a machine learning method can utilize a neural network object classifier generated by a large amount of training samples to establish classifying information about the plurality of objects. The monitoring image may include a lot of accidental situations, and it is difficult to correctly identify the accidental situations within the monitoring image happened at different scenes. Thus, the conventional machine learning method may collect a great quantity of error samples for adjusting classification efficiency of the neural network; however if the neural network object classifier utilizes the newly-added error sample to execute the classification training, an identifying accuracy the object classifier may be decayed. The monitoring camera cannot collect and train the error samples if being disposed on the environment without external network; even the monitoring camera has the external network, storage ability and computation ability of the monitoring camera may be overloaded due to the great quantity of training samples and error samples. Therefore, design of a machine continuous learning method capable of economizing the storage ability and the computation ability, and further improving classification accuracy effectively is an important issue in the related industry.

### SUMMARY OF THE INVENTION

The present invention provides a machine continuous learning method with a neural network object classifying function and a related monitoring camera apparatus for solving above drawbacks.

According to the claimed invention, a machine continuous learning method with a neural network object classifying function is applied to a processor with an object classifier. The machine continuous learning method includes utilizing the processor to receive an image, utilizing the object classifier to analyze the image for generating a first parameter and a second parameter, utilizing the processor to determine whether the first parameter is similar to at least one cluster established by human feedback, and utilizing the processor to output a label of the at least one cluster or the second parameter generated by the object classifier according to a determination result.

According to the claimed invention, a monitoring camera apparatus with a neural network object classifying function includes an image receiver and a processor. The image receiver is adapted to receive an image. The processor is electrically connected to the image receiver and has an object classifier. The processor is adapted to analyze the image via the object classifier for generating a first parameter and a second parameter, to determine whether the first parameter is similar to at least one cluster established by human feedback, and to output a label of the at least one cluster or the second parameter generated by the object classifier according to a determination result.

The monitoring camera apparatus can utilize the human feedback provided by the user to determine whether the sample of interest within the image is similar to the error sample, and further utilize the feature vector generated by the neural network object classifier to execute continuous learning, so as to establish and modify the cluster analysis result of the monitoring camera apparatus. As the new image is acquired, the object classifier can analyze the image to acquire the feature vector and the classifying result, and a classification accuracy can be determined via a comparison between the feature vector and the classifying result. If the feature vector of the image is not similar to the known cluster, the image is not reported as conforming to the error sample, so the classifying result can be directly output. If the feature vector of the image is similar to the known cluster, the image is represented as the error sample by the human feedback, so that the corresponding classifying result is wrong, and the label of the known cluster can be output accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a monitoring camera apparatus according to an embodiment of the present invention.

FIG. 2 and FIG. 3 are flow charts of a machine continuous learning method in different situations according to the embodiment of the present invention.

FIG. 4 is a functional block diagram of the machine continuous learning method according to the embodiment of the present invention.

### DETAILED DESCRIPTION

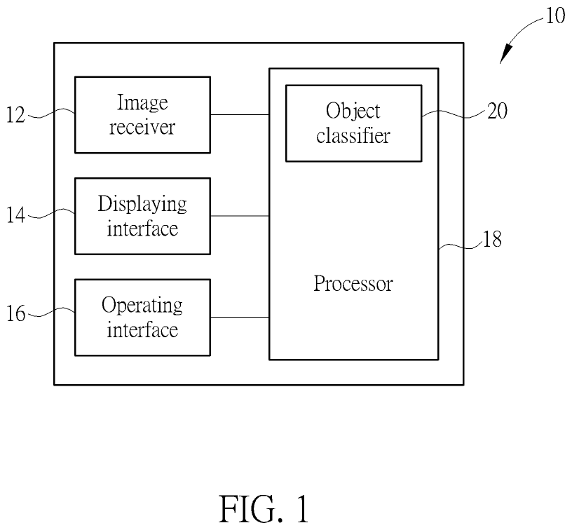

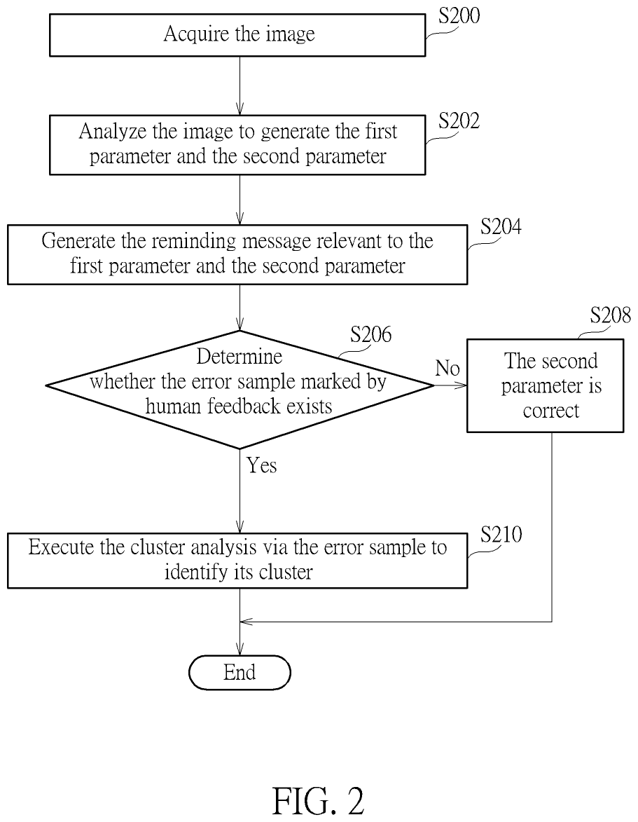

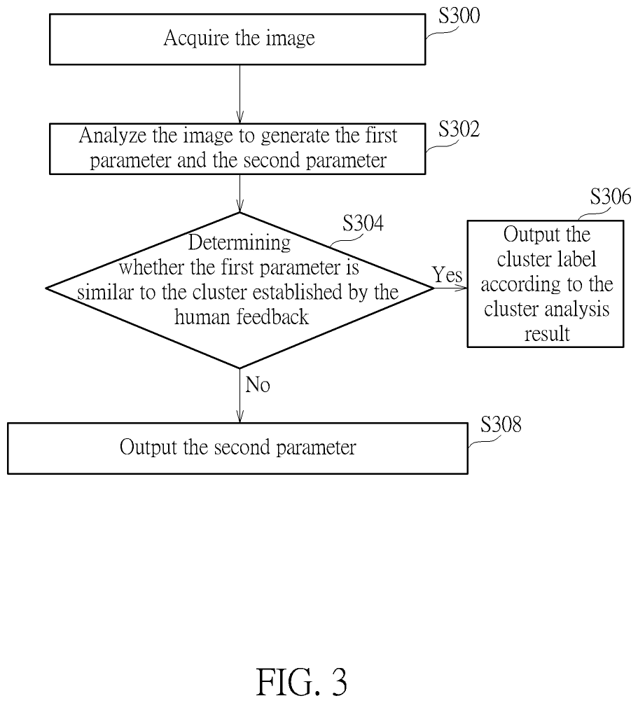

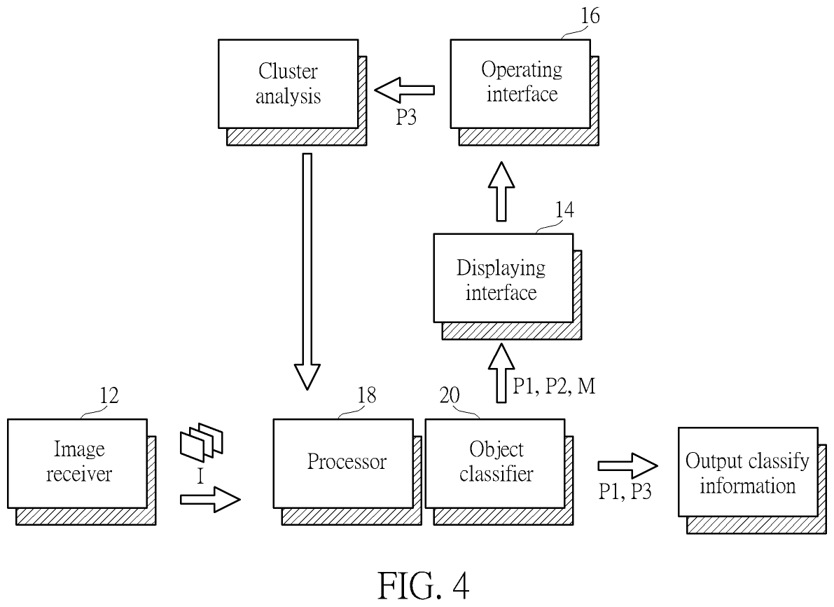

Please refer to FIG. 1 to FIG. 4. FIG. 1 is a functional block diagram of a monitoring camera apparatus 10 according to an embodiment of the present invention. FIG. 2 and FIG. 3 are flow charts of a machine continuous learning method in different situations according to the embodiment of the present invention. FIG. 4 is a functional block diagram of the machine continuous learning method according to the embodiment of the present invention. The machine continuous learning method illustrated in FIG. 2 to FIG. 4 can be suitable for the monitoring camera apparatus 10 shown in FIG. 1. The monitoring camera apparatus 10 can include an image receiver 12, a displaying interface 14, an operating interface 16 and a processor 18 electrically connected to each other. The image receiver 12 can be a camera adapted to directly capture an image I. The image receiver 12 further can be a signal receiver adapted to receive the image I captured by an external camera. The processor 18 can have an object classifier 20. The object classifier 20 can analyze the image I to generate a plurality of parameters P1 and P2, which represent property of a sample of interest. The processor 18 can utilize the machine continuous learning method to analyze the image I, and then acquire classifying information about the sample of interest within the image I via low speed operational ability in a surrounding without external network.

First, steps S200 and S202 are executed that the processor 18 can receive the image I acquired by the image receiver 12, and the object classifier 20 can analyze the image I to at least generate the first parameter P1 and the second parameter P2. In this embodiment, the first parameter P1 can be a feature vector about the sample of interest within the image I, and the second parameter P2 can be a classifying result about the sample of interest within the image I. Application of the parameters P1 and P2 are not limited to the above-mentioned embodiments, and depend on actual demand. According to computing ability and storage capacity of the monitoring camera apparatus 10, the object classifier 20 may use, but not be limited to, convolutional neural network to acquire the feature vector or a feature map of the image I in different layers. The feature in a high layer may be used as the first parameter P1, or the feature in a low layer may be used as the first parameter P1, or the features in the high layer and the low layer may be combined and represented as the first parameter P1, Variation of the high layer and the low layer is not limited to the above-mentioned embodiment, and depends to design demand. The second parameter P2 (such as the classifying result) can be an attribute about the sample of interest, such as a passerby, an inhuman object or a vehicle. Is should be mentioned that the processor 18 preferably can separate a foreground pattern from the image I to be the sample of interest, and the object classifier 20 can analyze the foreground pattern to generate the first parameter P1 and the second parameter P2 for lower loading of computation.

Steps S204 and S206 are executed that the processor 18 can generate a reminding message M relevant to the first parameter P1 and the second parameter P2 and display the reminding message M on the displaying interface 14, and then determine whether an error sample marked by human feedback exists. The user can watch the displaying interface 14 and utilizes the operating interface 16 to manually mark that the classifying result of the sample of interest is similar to the error sample when the said classifying result is wrong. If the processor 18 does not receive the error sample, step S208 can be executed to determine the second parameter P2 (which means the classifying result) is correct information. If the processor 18 receives the error sample, step S210 can be executed to execute the cluster analysis via the error sample for identifying which cluster is similar to the error sample. In the present invention, step S204 is an optional process, which can be omitted or be executed after any other steps in the machine continuous learning method. For example, the image I can be a monitoring frame about the road, and the object classifier 20 may identify a tree in the monitoring frame as the passerby. In this situation, the human feedback can mark that the classifying result is the error sample, and the cluster analysis in step S210 can analyze and determine whether the feature vector belongs to the first cluster (such as the human cluster) or the second cluster (such as the inhuman cluster). Thus, cluster classification of the machine continuous learning method can be applied to economize a storage quantity of the monitoring camera apparatus 10.

For the machine continuous learning method illustrated in FIG. 3, steps S300 and S320 are executed that the processor 18 can receive the image I acquired by the image receiver 12, and the object classifier 20 can analyze the sample of interest inside the image Ito generate the first parameter P1 and the second parameter P2. The error sample marked by the human feedback can have a third parameter P3 which represents a property of the sample of interest. Generally, the third parameter P3 can be a feature vector of the error sample, and have a property to the same as the property of the first parameter P1. Thus, step S304 is executed to compare the first parameter P1 with the third parameter P3 of the error sample or with the cluster formed by the third parameter P3 via the processor 18, for determining whether the first parameter P1 acquired in step S304 is similar to the cluster established by the human feedback. If the first parameter P1 is similar to the third parameter P3 or the cluster formed by the third parameter P3, the sample of interest can be represented as the error sample by the human feedback, so the corresponding second parameter P2 (which means the classifying result) is wrong information, and step S306 is executed to output a label of the corresponding cluster (such as the first cluster or the second cluster) according to a result of the previous cluster analysis. If the first parameter P1 is not similar to the third parameter P3 or the cluster formed by the third parameter P3, the sample of interest cannot conform to the cluster established by the human feedback, which means the sample of interest is not reported as being similar to the error sample, and step S308 is executed to directly output the second parameter P2 (such as the classifying result).

The machine continuous learning method of the present invention can analyze other property about the sample of interest within the image I for increasing classification accuracy. First, the object classifier 20 can analyze the image I to generate the specific datum, and the specific datum can be position information or time information about the sample of interest and/or the error sample. The processor 18 can compare the specific datum about the sample of interest (such as the position information or the time information) with the specific datum of the error sample (such as the position information or the time information) for determining whether the sample of interest is similar to the cluster established by the human feedback. As an example of the time information, if the sample of interest is determined as being similar to the specific cluster and the time information of the sample of interest is close to the time information of the error sample marked by the human feedback, the sample of interest can fit with the error sample, and the label of the specific cluster can be output directly. For instance, an insect appeared in the night may generate the wrong classifying result; if the monitoring frame (which means the image I) in the daytime determines the sample of interest is similar to the specific cluster, the classifying result is not modified even the time information cannot fit. If the sample of interest similar to the specific cluster is appeared in the monitoring frame captured in the night, the classifying result output by the monitoring camera apparatus 10 can be modified accordingly. Besides, when the sample of interest cannot fit with the specific datum of the error sample, the reminding message about the specific datum can be optionally displayed on the displaying interface 14.

In conclusion, the monitoring camera apparatus can utilize the human feedback provided by the user to determine whether the sample of interest within the image is similar to the error sample, and further utilize the feature vector generated by the neural network object classifier to execute continuous learning, so as to establish and modify the cluster analysis result of the monitoring camera apparatus. As the new image is acquired, the object classifier can analyze the image to acquire the feature vector and the classifying result, and a classification accuracy can be determined via a comparison between the feature vector and the classifying result. If the feature vector of the image is not similar to the known cluster, the image is not reported as conforming to the error sample, so the classifying result can be directly output. If the feature vector of the image is similar to the known cluster, the image is represented as the error sample by the human feedback, so that the corresponding classifying result is wrong, and the label of the known cluster can be output accordingly. Comparing to the prior art, the machine continuous learning method and the related monitoring camera apparatus of the present invention can execute classification training and updating without the external network. Each monitoring camera apparatus can establish the exclusive cluster according to the monitoring environment, and does not learn the training sample of other scenes; thus, the monitoring camera apparatus does not waste storage space to store a large amount of training samples, and a low-computation cluster analysis can be applied to obtain an accurate classifying result.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A machine continuous learning method with a neural network object classifying function, applied to a processor with an object classifier, the machine continuous learning method comprising:
utilizing the processor to receive an image;
utilizing the object classifier to analyze the image for generating a first parameter and a second parameter;
utilizing the processor to determine whether the first parameter is similar to at least one cluster established by human feedback; and
utilizing the processor to output a label of the at least one cluster or the second parameter generated by the object classifier according to a determination result.

2. The machine continuous learning method of claim 1, wherein the first parameter is a feature vector, and the second parameter is a classifying result.

3. The machine continuous learning method of claim 1, wherein the at least one cluster comprises a first cluster and a second cluster, the machine continuous learning method further comprises:
generating a reminding message relevant to the first parameter and the second parameter;
acquiring an error sample marked by the human feedback; and
executing cluster analysis via the error sample to identify the error sample is similar to the first cluster or the second cluster.

4. The machine continuous learning method of claim 3, wherein the first parameter is compared with a third parameter of the error sample to determine whether the first parameter is similar to the at least one cluster, and the third parameter is a feature vector of the error sample.

5. The machine continuous learning method of claim 3, wherein utilizing the processor to output the label of the at least one cluster or the second parameter generated by the object classifier according to the determination result comprises:
outputting the label of the first cluster or the second cluster according to a result of the cluster analysis when the first parameter is similar to the at least one cluster.

6. The machine continuous learning method of claim 3, wherein the reminding message is displayed on a displaying interface, the error sample is manually marked via an operating interface, and the displaying interface and the operating interface are electrically connected to the processor.

7. The machine continuous learning method of claim 1, further comprising:
separating a foreground pattern from the image, wherein the object classifier analyzes the foreground pattern to generate the first parameter and the second parameter.

8. The machine continuous learning method of claim 1, further comprising:
the object classifier analyzing the image to further generate a specific datum;
determining whether the specific datum conforms to a corresponding datum of an error sample marked by the human feedback; and
deciding whether to output the label of the at least one cluster according to a determination result.

9. The machine continuous learning method of claim 8, further comprising:
outputting the label of the at least one cluster when the first parameter is similar to the at least one cluster and the specific datum conforms to the corresponding datum.

10. The machine continuous learning method of claim 8, wherein a reminding message relevant to the specific datum is generated when the specific datum does not conform to the corresponding datum.

11. The machine continuous learning method of claim 8, wherein specific datum is position information or time information of the error sample marked by the human feedback.

12. A monitoring camera apparatus with a neural network object classifying function, comprising:
an image receiver adapted to receive an image; and
a processor electrically connected to the image receiver and having an object classifier, the processor being adapted to analyze the image via the object classifier for generating a first parameter and a second parameter, to determine whether the first parameter is similar to at least one cluster established by human feedback, and to output a label of the at least one cluster or the second parameter generated by the object classifier according to a determination result.

13. The monitoring camera apparatus of claim 12, wherein the first parameter is a feature vector, and the second parameter is a classifying result.

14. The monitoring camera apparatus of claim 12, wherein the at least one cluster comprises a first cluster and a second cluster, the processor is further adapted to generate a reminding message relevant to the first parameter and the second parameter, to acquire an error sample marked by the human feedback, and execute cluster analysis via the error sample to identify the error sample is similar to the first cluster or the second cluster.

15. The monitoring camera apparatus of claim 14, wherein the first parameter is compared with a third parameter of the error sample to determine whether the first parameter is similar to the at least one cluster, and the third parameter is a feature vector of the error sample.

16. The monitoring camera apparatus of claim 14, wherein the processor is further adapted to output the label of the first cluster or the second cluster according to a result of the cluster analysis when the first parameter is similar to the at least one cluster.

17. The monitoring camera apparatus of claim 14, wherein the reminding message is displayed on a displaying interface, the error sample is manually marked via an operating interface, and the displaying interface and the operating interface are electrically connected to the processor.

18. The monitoring camera apparatus of claim 12, wherein the processor is further adapted to separate a foreground pattern from the image, wherein the object classifier analyzes the foreground pattern to generate the first parameter and the second parameter.

19. The monitoring camera apparatus of claim 12, wherein the processor is further adapted to analyze the image via the object classifier for further generating a specific datum, to determine whether the specific datum conforms to a corresponding datum of an error sample marked by the human feedback, and to decide whether to output the label of the at least one cluster according to a determination result.

20. The monitoring camera apparatus of claim 19, wherein the processor is further adapted to output the label of the at least one cluster when the first parameter is similar to the at least one cluster and the specific datum conforms to the corresponding datum.

21. The monitoring camera apparatus of claim 19, wherein a reminding message relevant to the specific datum is generated when the specific datum does not conform to the corresponding datum.

22. The monitoring camera apparatus of claim 19, wherein specific datum is position information or time information of the error sample marked by the human feedback.
